(19) United States
(12) Patent Application Publication
(10) Pub. No.: US 2026/0167274 A1
(43) Pub. Date: Jun. 18, 2026

(54) ANGULARLY ADJUSTABLE MOUNTING POINT

(71) Applicant: DEIST INDUSTRIES, INC., Hadley, PA (US)

(72) Inventor: Benjamin C. Post, Hadley, PA (US)

(73) Assignee: DEIST INDUSTRIES, INC., Hadley, PA (US)

(21) Appl. No.: 19/068,083

(22) Filed: Mar. 3, 2025

Related U.S. Application Data
(63) Continuation-in-part of application No. 18/980,616, filed on Dec. 13, 2024.

(51) Int. Cl. B62D 27/06; B62D 27/02

(52) U.S. Cl. CPC B62D 27/065; B62D 27/023

(57) ABSTRACT

Provided in this disclosure is an adjustable mounting point for use with a hoist system, including a fixed bracket, a pivot bracket, and at least one mounting hole facilitating connection of an attachment to the mounting point. A fixation mechanism, a pivot mechanism, and adjustment mechanism may be included, and the adjustable mounting point may be configured to facilitate angular adjustment of the pivot bracket, relative to the fixed bracket, between a plurality of angles. The adjustable mounting point adjustment mechanism may be selectively positionable to adjust the angular position of the pivot bracket, relative to the fixed bracket, between the plurality of angles.

### I. BACKGROUND

### A. Technical Field

This invention pertains generally to the field of vehicles, such as trucks, that employ interchangeable bodies. In particular, the invention pertains to mounting point brackets for hoists that are used for mounting attachments onto such vehicle hoists.

### B. Description of Related Art

Vehicles such as trucks are known to have different types of bodies, including a flat bed, a dumping body, an enclosed freight body, etc. Trucks of the same class can have various different bodies mounted onto the same chassis. Typically, vehicles such as trucks have a dedicated body that is permanently mounted to a chassis. Such a truck is sold and used as one type of special purpose vehicle, for handling the special types of jobs associated with the dedicated body.

Vehicles with dedicated bodies are limited in use for only the types of special jobs that can be performed by that particular body. For example, a dump truck is only useful for dumping. Such vehicles can remain idle while their associated types of jobs are not being performed. A small business may not have the available resources to purchase and maintain a fleet of dedicated vehicles having different bodies. For this reason, vehicles having interchangeable bodies are known to have certain useful advantages. A truck using interchangeable bodies enables the same single vehicle to be converted and adapted for use with a variety of different jobs, without requiring a fleet of separate vehicles to be maintained.

Such vehicles with interchangeable bodies typically include a hoist for raising and mounting an interchangeable body onto a vehicle chassis. Such a common-type hoist includes a movable hoist frame for supporting an interchangeable body, which is mounted to a subframe that is welded onto the vehicle chassis. In this manner, the subframe is maintained in a fixed position. The hoist frame can be selectively elevated and inclined in such a manner as to allow an interchangeable body to be slidably mounted upon the chassis.

Though there are benefits to using interchangeable bodies, vehicles with interchangeable bodies are also subject to certain drawbacks. Such a vehicle must be dedicated for the specific use of mounting interchangeable bodies, since a welded hoist often precludes conversion to another single use vehicle. It is thus difficult to convert the vehicle back to other uses besides mounting interchangeable bodies due to damage to the chassis from welding. Also, welding is typically outsourced to a professional welder rather than performed by on-site personnel.

Moreover, the hoist can become damaged from repeated mountings and remountings of different types of interchangeable bodies. Replacing a damaged hoist can be a time-consuming matter due in part to scheduling outsourced welding services, resulting in vehicle down time. And the chassis can be further damaged by repeated welding operations from repeated hoist replacements, which can shorten vehicle life or require additional vehicle servicing to repair or replace the chassis.

In addition, previous type welded hoist systems are specifically sized to only permit a single length of interchangeable body to be deployed. Moreover, in such welded hoist systems, the components for elevating the hoist frames are hard mounted at a fixed maximum angle, which reduces the usefulness of certain interchangeable body types for certain applications.

### II. SUMMARY

In accordance with an aspect of the present invention, an adjustable mounting point for use with a hoist system, comprising a fixed bracket, disposed along the length of a hoist system subframe, having an inside surface, and fixedly connected to either of a first parallel subframe member or a second parallel subframe member. The adjustable mounting point may also include a pivot bracket, disposed adjacent to the fixed bracket, having an outside surface, and pivotally connected to the fixed bracket, at least one mounting hole disposed on the pivot bracket outside surface, which at least one mounting hole facilitates connection of an attachment assembly to the pivot bracket, and at least one fixation hole, disposed on the fixed bracket inside surface. A fixation mechanism may be included, which engages with the at least one fixation hole and the hoist subframe to fixedly connect the fixed bracket to the hoist subframe, and the adjustable mounting point may have at least one pivot hole, disposed on the fixed bracket, corresponding to and concentric with at least one pivot hole disposed on the pivot bracket. The adjustable mounting point may include a pivot mechanism, which engages with the fixed bracket and the pivot bracket to pivotally connect the pivot bracket to the fixed bracket, at least one adjustment hole, disposed on the fixed bracket, corresponding to and concentric with at least one adjustment hole disposed on the pivot bracket, and an adjustment mechanism, which is configured to facilitate angular adjustment of the pivot bracket, relative to the fixed bracket, between a plurality of angles. The adjustable mounting point as described above, may have an adjustment mechanism wherein the adjustment mechanism is selectively positionable between any of the at least one adjustment holes to adjust the angular position of the pivot bracket, relative to the fixed bracket, between the plurality of angles.

In accordance with another aspect of the present invention, the attachment assembly of the adjustable mounting point above may further include at least one connector, at least one accessory, and the at least one connector may be configured to be selectively engageable with the pivot bracket on a first end of the at least one connector, and configured to be selectively engageable with an accessory on a second end of the at least one connector.

In accordance with another aspect of the present invention, the attachment assembly of the adjustable mounting point above may further include at least one support structure, connected to a vehicle body and configured to support the at least one connector. The at least one connector of the attachment assembly may be an “L-shaped” bracket, and the first end of the at least one connector may be selectively engageable with the at least one mounting hole.

In accordance with another aspect of the invention, the adjustable mounting point above, wherein the fixation mechanism may be at least one bolt. The pivot mechanism may be a bolt, which extends across the length of the adjustable mounting point. The pivot mechanism may be a plurality of bolts. The adjustment mechanism may alternatively be a bolt, which extends across the length of the adjustable mounting point. The adjustable mounting point as described above, wherein the adjustment mechanism is a plurality of bolts. The adjustable mounting point as described above, wherein the plurality of angles includes a first angle, a second angle, and a third angle. The first angle may be 90 degrees, the second angle may be 93 degrees, and the third angle may be 87 degrees. The adjustable mounting point as described above, wherein the accessory is a winch hook stow.

In accordance with another aspect of the invention, an adjustable mounting point including a static bracket, disposed along the length of a hoist system subframe, having an outside surface, and fixedly connected to either of a first parallel subframe member or a second parallel subframe member. The adjustable mounting point may also include at least one mounting hole disposed on the outside surface of the static bracket, which at least one mounting hole may facilitate connection of an attachment assembly to the static bracket, and a fixation mechanism, which may engage with the static bracket and the hoist subframe to fixedly connect the static bracket to the hoist subframe. The static bracket may be configured to be non-dynamically set at an angular position, relative to the hoist subframe.

In accordance with another aspect of the invention, an adjustable mounting point, wherein the attachment assembly includes at least one connector, at least one accessory, and the at least one connector may be configured to be selectively engageable with the pivot bracket on a first end of the at least one connector, and configured to be selectively engageable with an accessory on a second end of the at least one connector. The attachment assembly of the adjustable mounting may further include at least one support structure, connected to a vehicle body and configured to support the at least one connector. The at least one connector of the attachment assembly may be an “L-shaped” bracket, and the first end of the at least one connector may be selectively engageable with the at least one mounting hole.

In accordance with another aspect of the invention, an adjustable mounting point for use with a hoist system, comprising a fixed bracket, disposed along the length of a hoist system subframe, having an inside surface, and fixedly connected to either of a first parallel subframe member or a second parallel subframe member, and a pivot bracket, disposed adjacent to the fixed bracket, having an outside surface, and pivotally connected to the fixed bracket. At least one mounting hole may be disposed on the pivot bracket outside surface, which at least one mounting hole facilitates connection of an attachment assembly to the pivot bracket, and at least one fixation hole may be disposed on the fixed bracket inside surface. A fixation mechanism may engage with the at least one fixation hole and the hoist subframe to fixedly connect the fixed bracket to the hoist subframe, wherein the fixation mechanism is at least one bolt. At least one pivot hole may be disposed on the fixed bracket, corresponding to and concentric with at least one pivot hole disposed on the pivot bracket, and a pivot mechanism may engage with the fixed bracket and the pivot bracket to pivotally connect the pivot bracket to the fixed bracket, wherein the pivot mechanism is a bolt, which extends across the length of the adjustable mounting point. At least one adjustment hole may be disposed on the fixed bracket, corresponding to and concentric with at least one adjustment hole disposed on the pivot bracket. An adjustment mechanism may facilitate angular adjustment of the pivot bracket, relative to the fixed bracket, between a first angle of 90 degrees, a second angle of 93 degrees, and a third angle of 87 degrees, wherein the adjustment mechanism is a plurality of bolts, and a correspondingly equal number of bolts is disposed on each of the adjustable mounting point first side and the adjustable mounting point second side, and wherein the attachment may be a fender bracket. The adjustment mechanism may be selectively positionable between any of the at least one adjustment holes to adjust the angular position of the pivot bracket, relative to the fixed bracket, between the first angle, the second angle, and the third angle. The attachment assembly of the adjustable mounting point above may further include at least one connector, at least one accessory, and the at least one connector may be configured to be selectively engageable with the pivot bracket on a first end of the at least one connector, and configured to be selectively engageable with an accessory on a second end of the at least one connector. The attachment assembly of the adjustable mounting point above may further include at least one support structure, connected to a vehicle body and configured to support the at least one connector. The at least one connector of the attachment assembly may be an “L-shaped” bracket, and the first end of the at least one connector may be selectively engageable with the at least one mounting hole.

Other benefits and advantages of this invention will become apparent to those skilled in the art to which it pertains upon reading and understanding of the following detailed specification.

### III. BRIEF DESCRIPTION OF THE DRAWINGS

The disclosed adjustable mounting point may take physical form in certain parts and arrangement of parts, embodiments of which will be described in detail in this specification and illustrated in the accompanying drawings which form a part hereof and wherein:

FIG. 1 is a perspective view of a complete hoist system 100;

FIG. 2 is a perspective view of the hoist system subframe assembly 110;

FIGS. 3A, 3B, 3C, and 3D are perspective, top, side, and front views of the adjustable mounting point 300;

FIG. 4 is an exploded view of the adjustable mounting point 300;

FIGS. 5A, 5B, and 5C are side views of the adjustable mounting point 300, showing alternatively the first angle 500, second angle 502, and third angle 504, respectively;

FIG. 6 is a perspective view of the fixed bracket 302 being installed on the hoist system parallel subframe member;

FIG. 7 is a close view of the adjustable mounting point installed on a hoist system subframe assembly 110;

FIG. 8A is a perspective view of the adjustable mounting point installed on a hoist system subframe assembly 110, with an accessory (here, a fender bracket) attached to the adjustable mounting point 300;

FIG. 8B is a detail view of Section A of FIG. 8A;

FIG. 9 is a view of the attachment assembly installed on a hoist system on a vehicle;

FIGS. 10A, 10B, and 10C are various close perspective views of the attachment assembly of FIG. 9;

FIG. 11 is a close view of a connector according to some embodiments of the present invention;

FIGS. 12A, 12B, 12C, and 12D are various close perspective views of the connector of FIG. 11 engaged with an adjustable mounting point according to some embodiments of the present invention;

FIGS. 13A, 13B, 13C, and 13D are various perspective views of a support structure according to some embodiments of the present invention;

FIGS. 14A, 14B, and 14C are various close perspective views of an alternative embodiment of an adjustable mounting point;

FIG. 15 is a close perspective view of a winch hook stow according to some embodiments of the present invention.

### IV. DETAILED DESCRIPTION

The following patents and patent applications are incorporated herein by reference in their entireties: U.S. Pat. No. 11,214,186 for HOIST FOR VEHICLE WITH INTERCHANGEABLE BODY, first named inventor Andrew J. Schumacher; U.S. Pat. No. 11,833,952 for HOIST FOR VEHICLE WITH INTERCHANGEABLE BODY, first named inventor Brian L. Jarrett; U.S. patent application Ser. No. 18/481,037 for HOIST FOR VEHICLE WITH INTERCHANGEABLE BODY, first named inventor Brian L. Jarrett; U.S. patent application Ser. No. 18/394,863 for HOIST FOR VEHICLE WITH INTERCHANGEABLE BODY, first named inventor Brian L. Jarrett; and U.S. patent application Ser. No. 18/915,006 for HOIST SYSTEM FOR CLASS 3 VEHICLE, first named inventor Derek Connors. The present application is a continuation-in-part of U.S. patent application Ser. No. 18/980,616 filed Dec. 13, 2024, the disclosure of which is incorporated herein by reference in its entirety.

Referring now to the drawings wherein the showings are for purposes of illustrating embodiments of the article only and not for purposes of limiting the same, and wherein like reference numerals are understood to refer to like components:

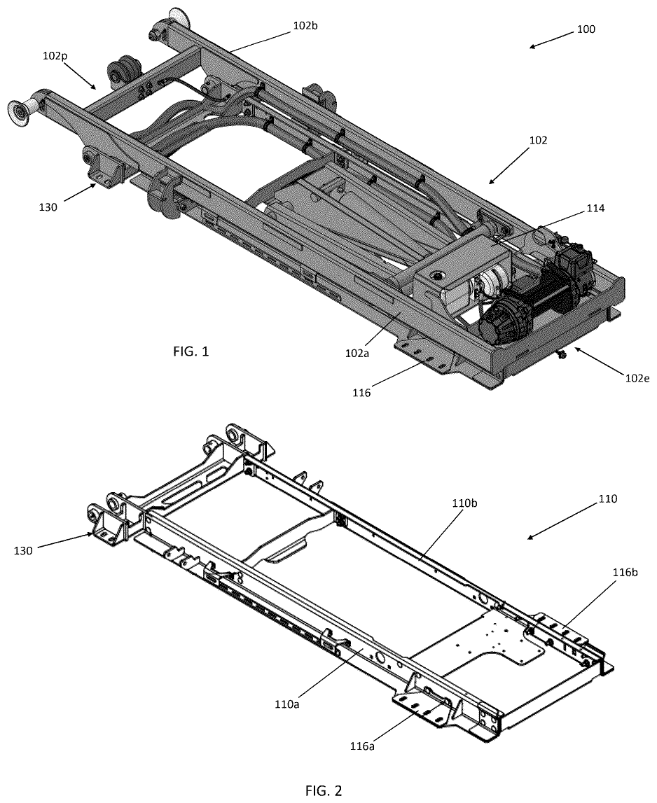

FIG. 1 is a perspective view showing an exemplary embodiment of a hoist system 100 according to the present invention. The hoist system 100 includes a hoist frame 102 for raising and mounting an interchangeable vehicle body onto a vehicle chassis. The hoist frame 102 is defined by first and second parallel frame members 102a, 102b. The hoist frame 102 is provided for slidably supporting the interchangeable body. The hoist frame 102 includes a pivot end 102p, about which the hoist frame 102 pivots, and an elevated end 102e, which is elevated when raising and mounting the interchangeable vehicle body, as will be described in greater detail hereinbelow. The frame members 102a, 102b extend along the longitudinal axis of the hoist frame 102 that extends between the elevated end 102e and the pivot end 102p.

It is to be appreciated that the present specification includes descriptions of similar components such as the frame members 102a, 102b in which identical corresponding structures are described and given similar reference numerals. Insofar as both of such corresponding structures may not be clearly shown in a particular view, especially a detail view, it is to be understood and appreciated such corresponding structures resemble the structures that are clearly shown in the views.

As shown in FIGS. 1 and 2, a subframe 110 is provided for ultimately connecting the hoist frame 102 to the vehicle chassis. The subframe 110 is defined by a bolt-on assembly for fixedly connecting the hoist frame 102 to the vehicle chassis and may include first and second parallel subframe members 110a, 110b. Specifically, the subframe 110 is connected to the vehicle chassis at the mounting brackets 116a, 116b, and the hinge assembly 130. The mounting brackets 116a, 116b are formed integrally with the subframe 110 and may include mounting portions that engage the vehicle chassis. The mounting portions may each include a series of mounting holes that receive bolts to enable the mounting brackets 116a, 116b, and thus the subframe 110 to be bolted to the vehicle chassis. Similar structures may be included on the hinge assembly 130 as will be explained hereinbelow. A cover 114 is provided to protect the pump from damage. The cover 114 can be made of metal or plastic or any other suitable material.

The subframe 110 is sized so that the mounting brackets 116a, 116b can be bolted on to first and second parallel vehicle chassis members. It is to be appreciated that the pump plate 114 can be easily bolted into different locations of the subframe 110 to accommodate different classes of vehicles and different hoist capacities and dump angles (as will be explained in greater detail hereinbelow). The subframe 110 thus eliminates the need for welding to the vehicle chassis and the resulting damage thereto. The mounting portions 116 are reinforced members for providing support to the hoist system 100. This enables the subframe 110 to be made of prefabricated sheet metal portions, which is a lighter, less expensive material than the structural steel used with previous type welded hoist systems, resulting in improved economy and efficiency with the present invention.

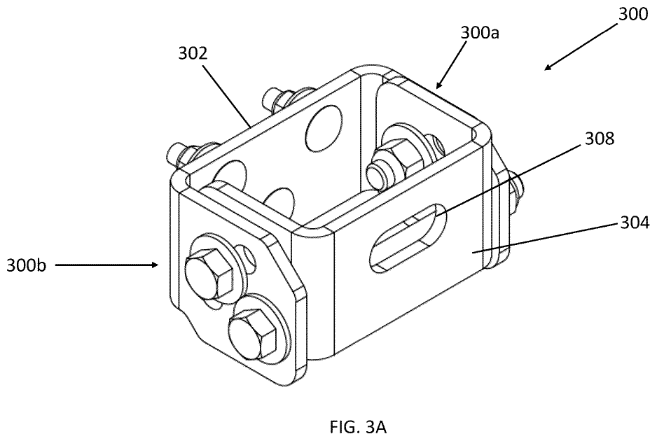

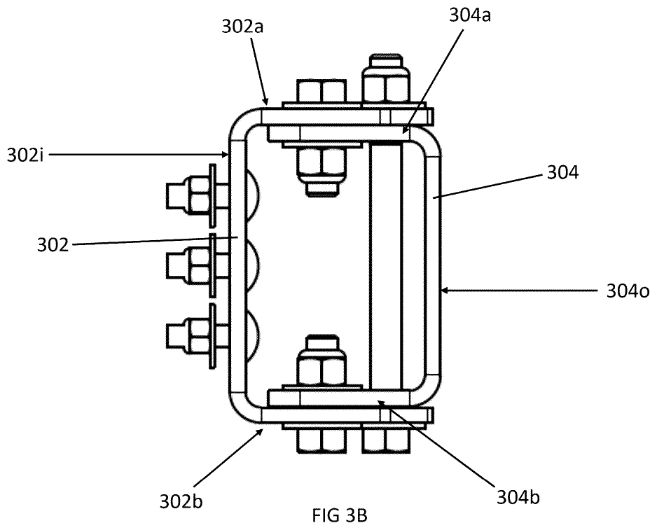

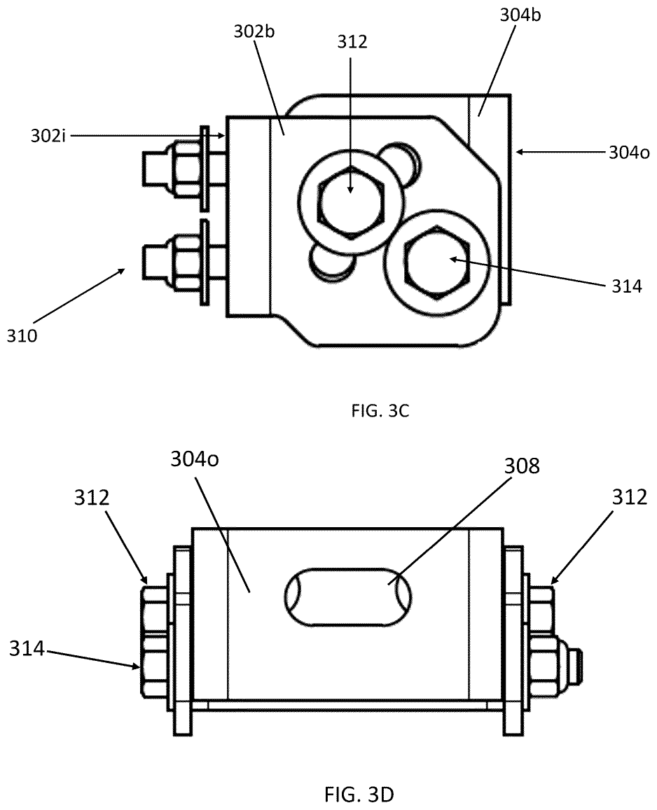

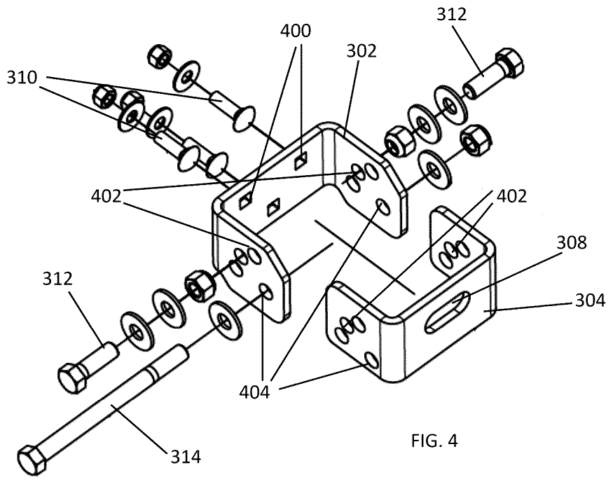

Referring now to FIGS. 3A, 3B, 3C, 3D, and 4 the adjustable mounting point 300 may include a first mounting point side 300a and a second mounting point side 300b, a fixed bracket 302, a pivot bracket 304, at least one mounting hole 308, at least one fixation hole 400, a fixation mechanism 310, at least one pivot hole 404, a pivot mechanism 314, at least one adjustment hole 402, and an adjustment mechanism 312. The fixed bracket 302 may be disposed along the length of the hoist system subframe 110 (in a manner and effect as described in further detail below) and may have a first fixed bracket side 302a and a second fixed bracket side 302b, and an inside surface 302i. The pivot bracket 304 may be disposed adjacent to the fixed bracket 302 and may have a first pivot bracket side 304a and a second pivot bracket side 304b, an outside surface 304o, and be pivotally connected to the fixed bracket 302 in a manner described further below. The mounting hole(s) 308 may be disposed on the pivot bracket outside surface 304o and may facilitate connection of an attachment to the pivot bracket 304 in a manner described further below. The brackets may define a generally “C-shaped” profile, and the fixed bracket 302 may include at least one chamfered corner.

With particular reference to FIG. 4, the fixation hole(s) 400 may be disposed on the fixed bracket inside surface 302i. The fixation mechanism 310 may engage the fixation hole(s) 400 and the hoist subframe 110 in a manner described further below. The fixation mechanism 310 can include bolts, rivets, screws, washers, nuts or any other connector chosen according to sound engineering judgment.

The pivot hole(s) 404 may be disposed on the fixed bracket 302, corresponding to and concentric with similar pivot hole(s) disposed on the pivot bracket 304. The pivot hole(s) located on the fixed bracket 302 may align with the pivot holes located on the pivot bracket 304. The pivot mechanism 314 may engage with the fixed bracket 302 and the pivot bracket 304 in a manner described further below. The pivot mechanism 314 can include bolts, rivets, screws, washers, nuts or any other connector chosen according to sound engineering judgment.

The adjustment hole(s) 402 may be disposed on the fixed bracket 302, corresponding to and concentric with similar adjustment hole(s) disposed on the pivot bracket 304. The adjustment hole(s) 402 located on the fixed bracket 302 may align with the pivot holes located on the pivot bracket 304. The adjustment mechanism 312 may engage with the fixed bracket 302 and the pivot bracket 304 in a manner described further below. The adjustment mechanism 312 can include bolts, rivets, screws, washers, nuts or any other connector chosen according to sound engineering judgment.

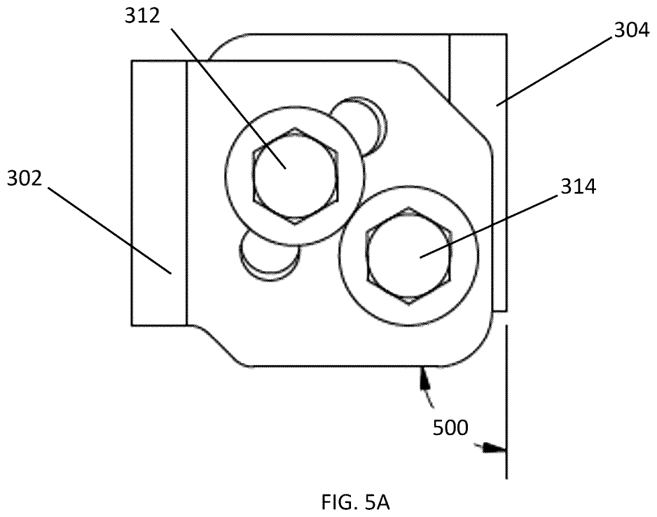

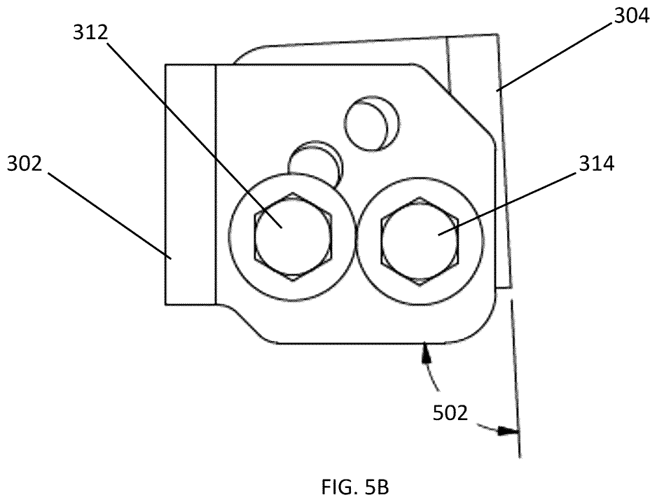

Referring now to FIGS. 3B, 4, 5A, 5B, and 5C, the pivot hole(s) 404, pivot mechanism 314, adjustment hole(s) 402, and adjustment mechanism 312, may be configured, and may work in conjunction with the fixed bracket 302 and pivot bracket 304 to both secure the brackets together and facilitate angular adjustment of the pivot bracket 304, relative to the fixed bracket 302. In a particular embodiment the pivot mechanism 314 may include a single-bolt design, and the adjustment mechanism 312 may be a two-bolt design. The pivot mechanism 314 may be configured to pivotally connect the pivot bracket 304 to the fixed bracket 302. In the present embodiment, the single bolt of the pivot mechanism 314 may extend through the pivot hole(s) 404 and be secured by a washer-nut assembly on either side of the bolt, creating a connection that pivotally secures the pivot bracket 304 and fixed bracket 302 but is loose enough to allow free rotation of the pivot bracket 304 and fixed bracket 302 relative to each other. The adjustment mechanism 312—in this embodiment, two separate bolt-washer-nut assemblies, one of which may be disposed on the first sides of the fixed and pivot brackets 302a, 304a, and the other of which may be disposed on the second sides of the fixed and pivot brackets 302b, 304b—may engage with the fixed bracket 302 and the pivot bracket 304 to alternatively lock and free the rotational motion of the pivot bracket 304 and fixed bracket 302, relative to each other. The adjustment hole(s) 402 may provide optional points at which the adjustment mechanism 312 can engage the brackets. In the present embodiment, three different pivot holes 404 allow the pivotal connection between the pivot bracket 304 and fixed bracket 302 to be locked at three particular angles, here a first angle 500, second angle 502, and third angle 504, respectively. In this manner, the adjustment mechanism 312 may be selectively positionable between any of the adjustment hole(s) 402 to adjust the angular position of the pivot bracket 304, relative to the fixed bracket 302, between the first angle 500, the second angle 502, and the third angle 504 (as shown in FIGS A, B, and C). In the present embodiment, the angles between the pivot bracket and the fixed bracket are 90 degrees (500), 93 degrees (502), and 87 degrees (504), but the disclosure contemplates that the number of optional angles—and, by extension, the number and nature of adjustment holes—as well as the angular degree or increments of those angular deviations may be any amount or quantity required by the mounting point's 300 application and by sound engineering judgment. In alternative embodiments, the pivot mechanism and adjustment mechanism, both or either, may include either of a single-bolt or two-bolt design. In yet another alternative embodiment, the adjustment hole(s) 402 may be a continuous oblong-shaped adjustment channel to facilitate a greater number of angles with finer adjustable angle deviations.

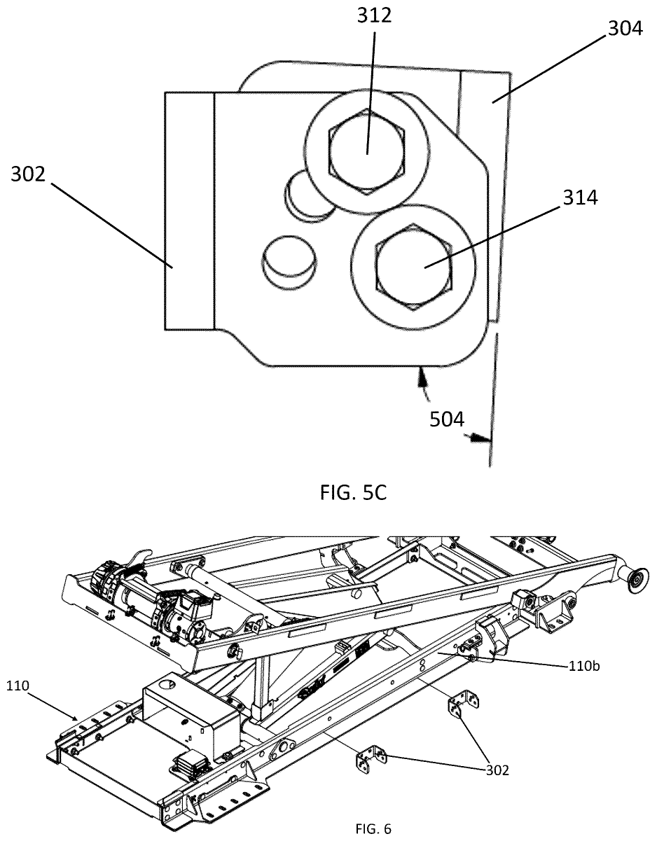

With reference to FIGS. 2, 4, 6, and 7, the adjustable mounting point 300 may be configured to affix to the hoist subframe 110. The fixation mechanism 310 may engage with the fixation hole(s) 400 and hoist subframe 110 to fixedly connect the fixed bracket 302 and fixed bracket inside surface 302i to either side of the hoist subframe 110, to either of the first or second parallel subframe members 110a, 110b. The pivot bracket may be secured to the fixed bracket in the manner described above, via the pivot hole(s) 404, pivot mechanism 314, adjustment hole(s) 402, and adjustment mechanism 312. The adjustable mounting point 300 may be disposed at any point along the lengths of each of the first and second parallel subframe members 110a, 110b.

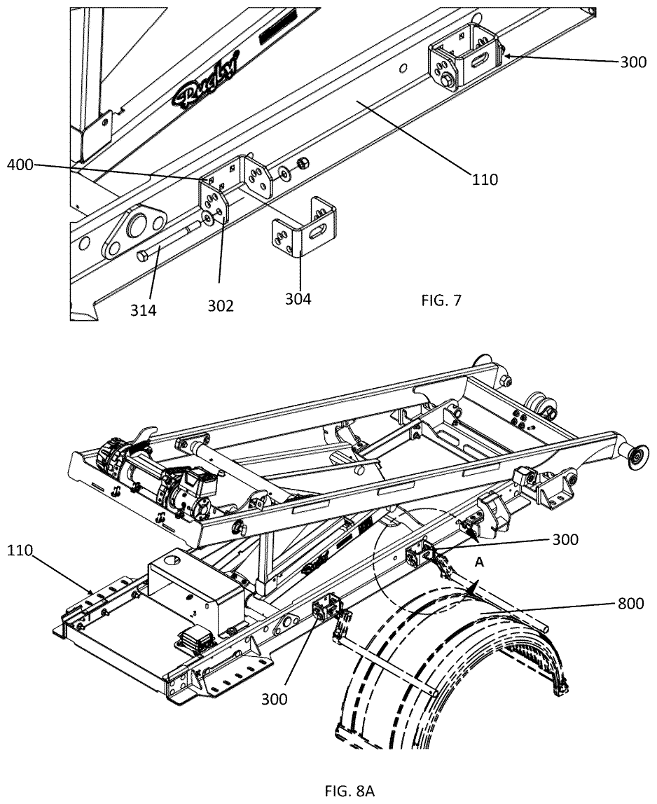

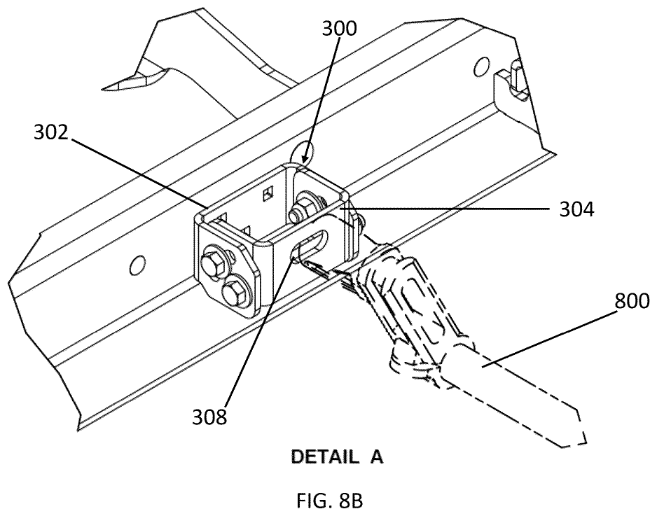

With reference now to FIGS. 7, 8A, and 8B, the adjustable mounting point 300 may afford mounting points that may be of various shapes and sizes to accommodate attachments 800 for connection to the hoist 100 and hoist subframe 110. The fixed bracket 302 and fixed bracket inside surface 302i may be fixedly secured to either side of the hoist subframe 110, to either of the first or second parallel subframe members 110a, 110b, as described above, and the pivot bracket 304 may be rotatably secured to the fixed bracket 302 such that the pivot bracket outside surface 304o and the mounting hole(s) 308 extend out (facing away) from the first or second parallel subframe member 110a, 110b, respectively. As shown specifically in FIGS. 8A and 8B, the mounting hole(s) 308 may serve as a point for attachments 800 to be affixed to the adjustable mounting point 300, via bolts, rivets, screws, washers, nuts or any other connector chosen according to sound engineering judgment. In a particular embodiment, the accessory may be a fender mount, but this disclosure also contemplates other such attachments 800. Attachments 800 can be various desirable accessories for the hoist subframe, which may include but are not limited to, fender brackets, tool boxes, mud flaps, guide rails, guard rails, fenders, tarp arms, fuel filler neck brackets, or any other attachments chosen according to the mounting point's 300 specific application and sound engineering judgment.

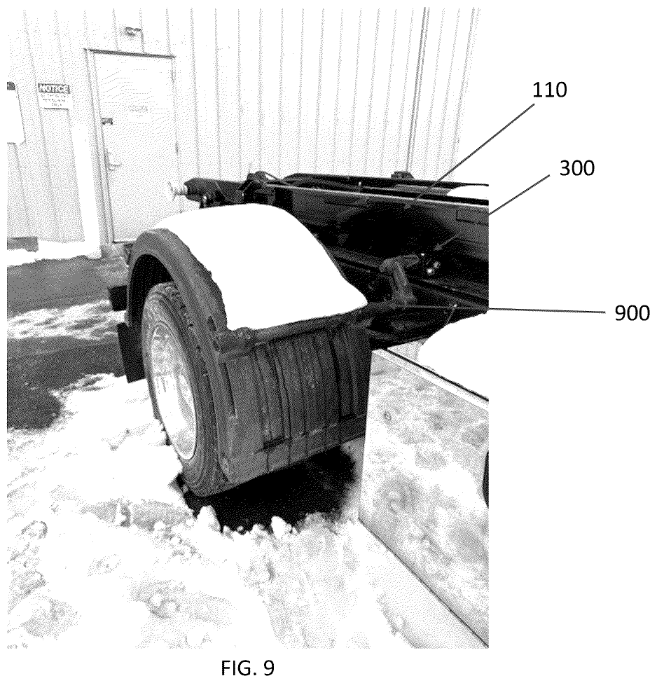

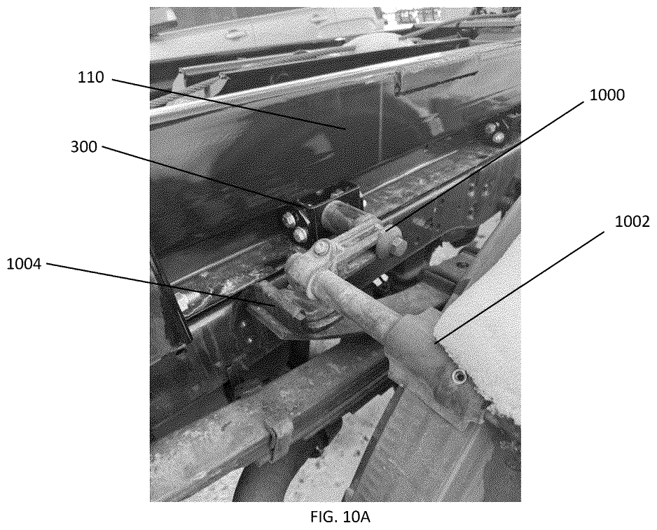

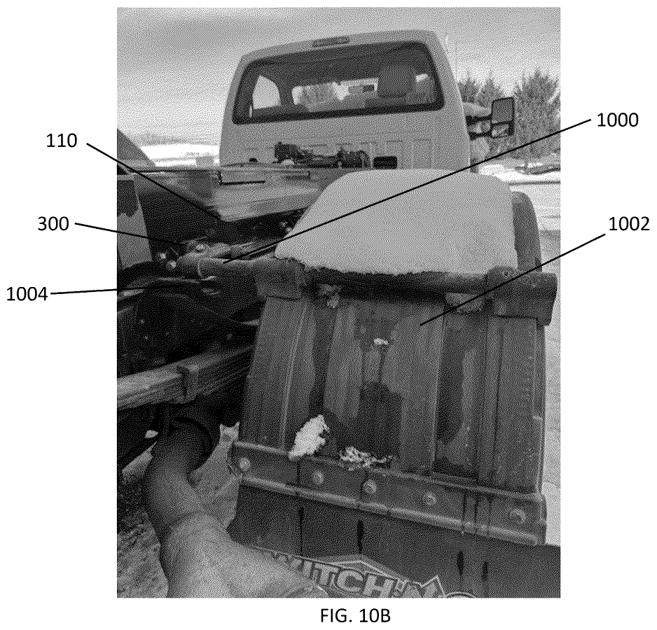

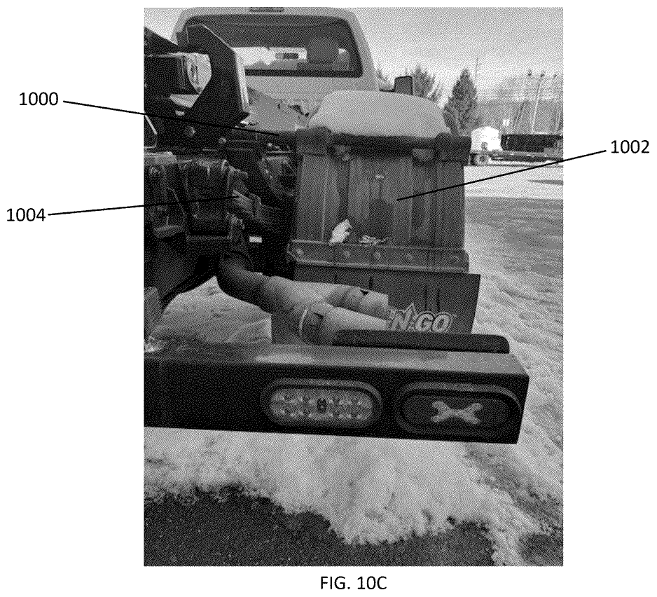

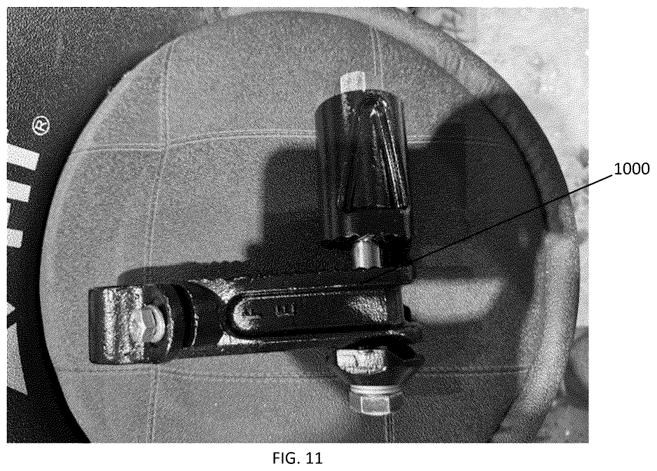

With reference now to FIGS. 9, 10A, 10B, 10 C, and 11, and in a particular embodiment of the present invention, the adjustable mounting point 300 may include an attachment assembly 900. The attachment assembly 900 itself may include at least one connector 1000 and at least one accessory 1002. Further, the attachment assembly 900 may include at least one support structure 1004. In some nonlimiting embodiment the at least one connector 1000 of the attachment assembly 900 may be an “L-shaped” bracket, but it should be understood that the connector may take a variety of forms including linear, tubular, “Z-shaped,” semicircular, and/or any other form chosen according to sound engineering judgment and the circumstance of use of the connector 1000.

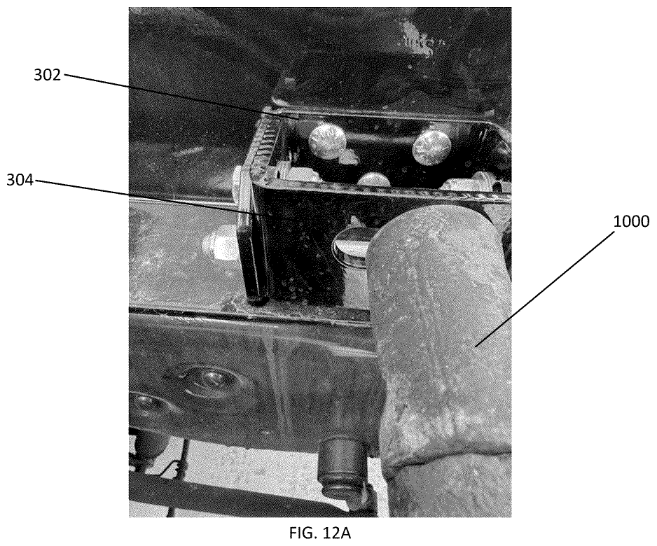

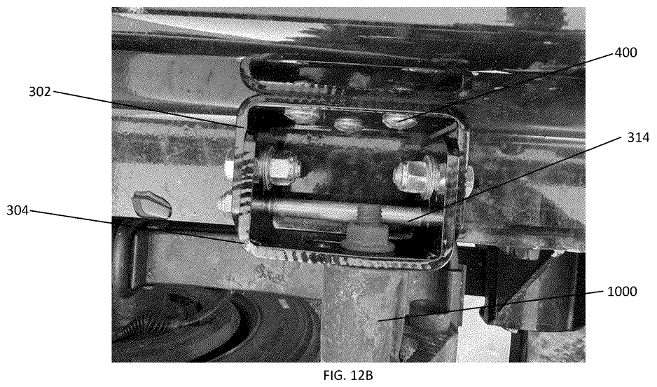

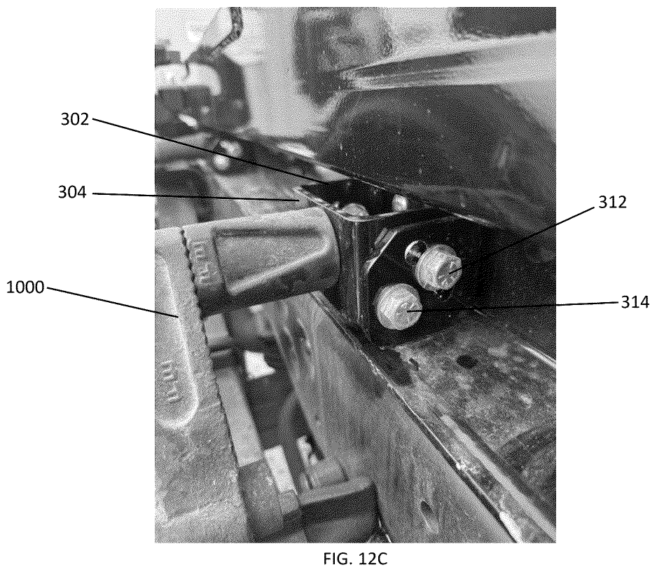

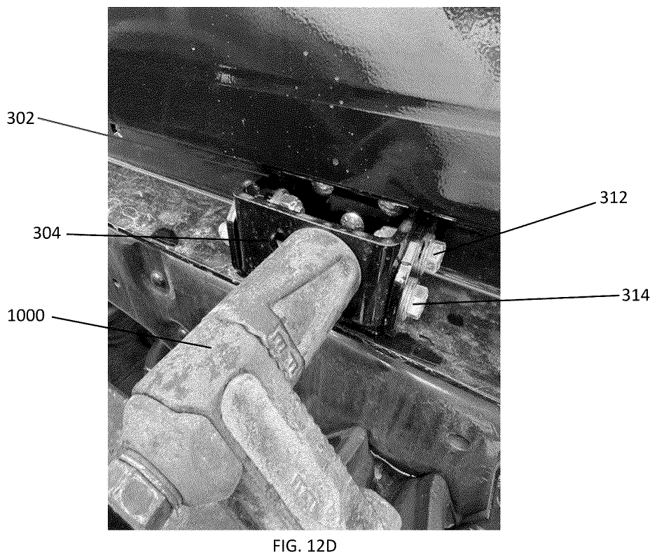

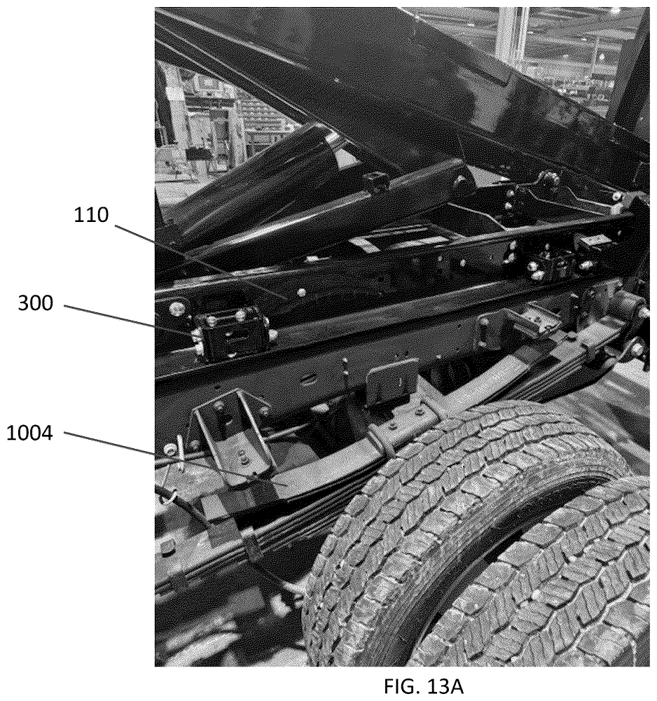

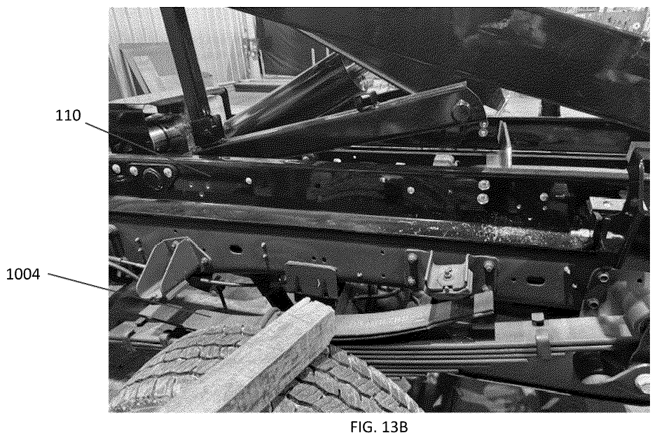

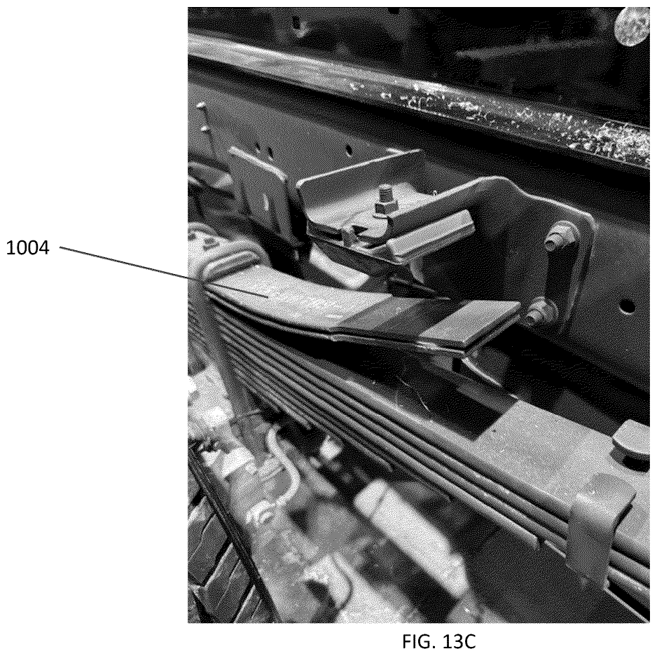

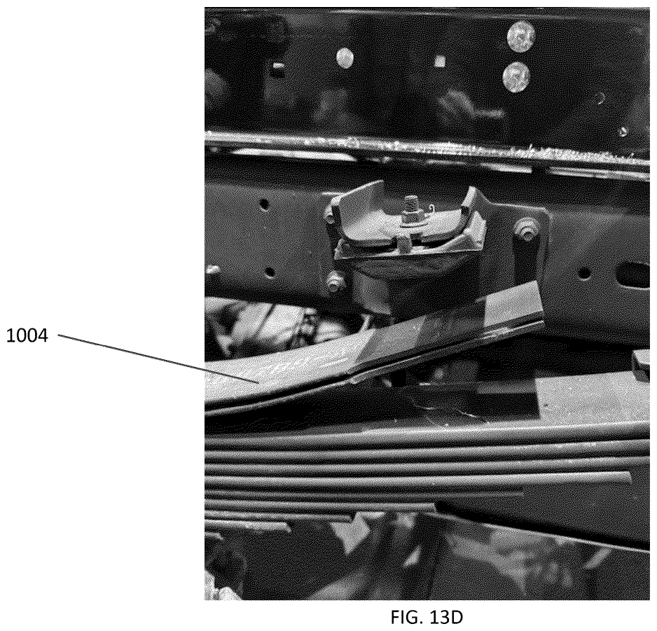

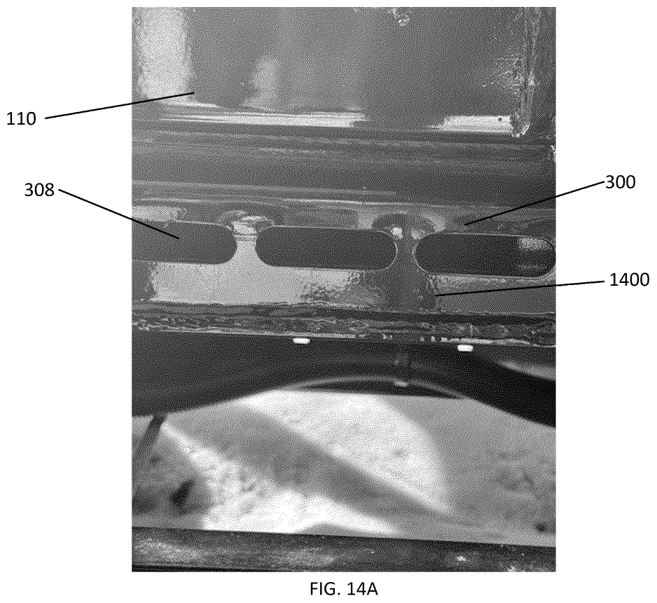

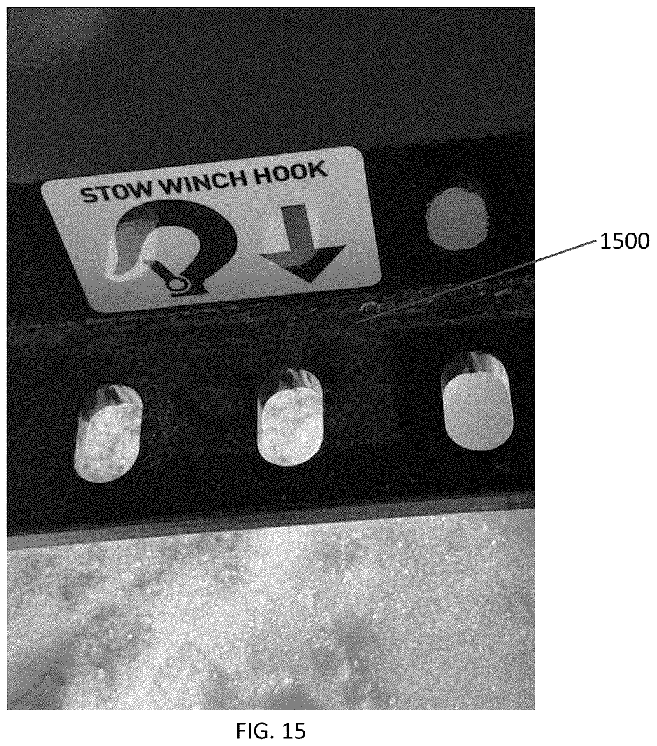

With reference to FIGS. 10A, 12A, 12B, 12C, 12D, 13A, 13B, 13C, 13D, and 15, in a particular embodiment, the connector 1000 may selectively engage with the mounting holes 308 on the pivot bracket 304. On another end of the connector, a use may connect any of a number of different accessories 1002, which accessories may include, but are not limited to, fender brackets, tool boxes, mud flaps, guide rails, guard rails, fenders, tarp arms, fuel filler neck brackets, a winch hook stow, or any other attachments chosen according to sound engineering judgment and the mounting point's 300 specific application. In particular embodiments wherein the pivot mechanism 314, adjustment hole(s) 402, and adjustment mechanism 312, may be configured, and may work in conjunction with the fixed bracket 302 and pivot bracket 304 to both secure the brackets together and facilitate angular adjustment of the pivot bracket 304, relative to the fixed bracket 302, the angular adjustability of the mounting point 300 may allow for dynamic positioning of the connector 1000 and, by extension, the accessory 1002. By utilizing the adjustment mechanism 312 to vary the angular position of the pivot bracket 304, the connector 1000 can be set at different angles, and the accessory can be set to different positions, relative to the hoist subframe 110 and the vehicle. A support structure 1004 may be connected to the vehicle and may afford support to the connector 1000. In a particular embodiment, the support structure may be a shock absorber, but it should be understood that the support structure may be a fixed beam, a bracket, a spring, or any other support device chosen according to sound engineering judgment. It should be noted and understood that, in the context of the foregoing embodiments, the attachment assembly may be interchangeable with the attachment 800 shown in FIGS. 8A & 8B.

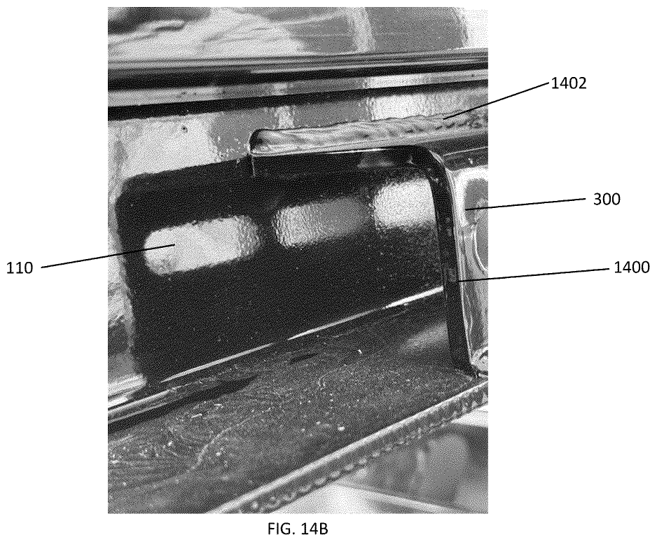

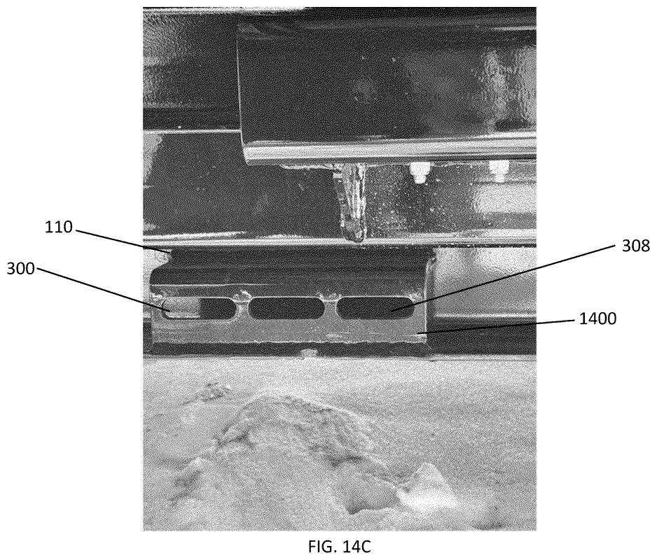

With further refence to FIGS. 14A, 14B, and 14C, and in a particular embodiment for applications where dynamic positioning is not preferred, the adjustable mounting point 300 may be a static-angle mounting point, having a static bracket 1400, disposed along the length of the hoist system subframe 110. Mounting holes 308 may be disposed on the static bracket 1400 to facilitate connection of an attachment assembly 900 to the static bracket 1400, and a fixation mechanism 1402, which may engage with the static bracket 1400 and the hoist subframe 110 to fixedly connect the static bracket 1400 to the hoist subframe 110. In a particular embodiment, the fixation mechanism 1402 may be a weldment, but it should be understood that the fixation mechanism 1402 may be rivets, bolts, screws, or any other fastener chosen according to sound engineering judgment. The static bracket 1400 may be installed at any angular position, to be non-dynamically set at the angular position, relative to the hoist subframe 110. In a particular embodiment the installation angle may be optionally between the first angle 500, the second angle 502, and the third angle 504 (as shown in FIGS A, B, and C). In a particular embodiment, the angles between the static bracket 1400 and the hoist subframe 110 may be 90 degrees (500), 93 degrees (502), and 87 degrees (504), but the disclosure contemplates that the number of optional angles, as well as the angular degree or increments of those angular deviations, may be any amount or quantity required by the mounting point's 300 application and by sound engineering judgment.

Numerous aspects have been described, hereinabove. While the adjustable mounting point 300 provided herein has been described in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined to provide the desired characteristics. It will be apparent to those skilled in the art that the above methods and apparatuses may incorporate changes and modifications without departing from the spirit and scope of the present disclosure. It is intended to include all such modifications and alterations in so far as they come within the scope of the appended claims or the equivalents thereof. Therefore, the holder apparatus should not be limited to any single embodiment, but rather construed in breadth and scope in accordance with the recitations of the appended claims.

Having thus described the invention, it is now claimed:

What is claimed:

1. An adjustable mounting point for use with a hoist system, comprising:
a fixed bracket, disposed along the length of a hoist system subframe, having an inside surface, and fixedly connected to either of a first parallel subframe member or a second parallel subframe member;
a pivot bracket, disposed adjacent to the fixed bracket, having an outside surface, and pivotally connected to the fixed bracket;
at least one mounting hole disposed on the pivot bracket outside surface, which at least one mounting hole facilitates connection of an attachment assembly to the pivot bracket;
at least one fixation hole, disposed on the fixed bracket inside surface;
a fixation mechanism, which engages with the at least one fixation hole and the hoist subframe to fixedly connect the fixed bracket to the hoist subframe;
at least one pivot hole, disposed on the fixed bracket, corresponding to and concentric with at least one pivot hole disposed on the pivot bracket;
a pivot mechanism, which engages with the fixed bracket and the pivot bracket to pivotally connect the pivot bracket to the fixed bracket;
at least one adjustment hole, disposed on the fixed bracket, corresponding to and concentric with at least one adjustment hole disposed on the pivot bracket; and
an adjustment mechanism, which is configured to facilitate angular adjustment of the pivot bracket, relative to the fixed bracket, between a plurality of angles.

2. The adjustable mounting point of claim 1, wherein the attachment assembly comprises:
at least one connector;
at least one accessory; and
wherein the at least one connector is configured to be selectively engageable with the pivot bracket on a first end of the at least one connector, and configured to be selectively engageable with an accessory on a second end of the at least one connector.

3. The adjustable mounting point of claim 2, wherein the attachment assembly further comprises at least one support structure, connected to a vehicle body and configured to support the at least one connector.

4. The adjustable mounting point of claim 2, wherein:
the at least one connector is an “L-shaped” bracket; and
the first end of the at least one connector is selectively engageable with the at least one mounting hole.

5. The adjustable mounting point of claim 2, wherein the adjustment mechanism is selectively positionable between any of the at least one adjustment holes to adjust the angular position of the pivot bracket, relative to the fixed bracket, between the plurality of angles.

6. The adjustable mounting point of claim 5, wherein the attachment assembly further comprises at least one support structure, connected to a vehicle body and configured to support the at least one connector.

7. The adjustable mounting point of claim 5, wherein:
the at least one connector is an “L-shaped” bracket; and
the first end of the at least one connector is selectively engageable with the at least one mounting hole.

8. The adjustable mounting point of claim 5, wherein the fixation mechanism is at least one bolt.

9. The adjustable mounting point of claim 5, wherein the pivot mechanism is a bolt, which extends across the length of the adjustable mounting point.

10. The adjustable mounting point of claim 5, wherein the pivot mechanism is a plurality of bolts.

11. The adjustable mounting point of claim 5, wherein the adjustment mechanism is a bolt, which extends across the length of the adjustable mounting point.

12. The adjustable mounting point of claim 5, wherein the adjustment mechanism is a plurality of bolts.

13. The adjustable mounting point of claim 5, wherein the plurality of angles includes a first angle, a second angle, and a third angle.

14. The adjustable mounting point of claim 5, wherein the accessory is a winch hook stow.

15. An adjustable mounting point for use with a hoist system, comprising:
a static bracket, disposed along the length of a hoist system subframe, having an outside surface, and fixedly connected to either of a first parallel subframe member or a second parallel subframe member;
at least one mounting hole disposed on the outside surface of the static bracket, which at least one mounting hole facilitates connection of an attachment assembly to the static bracket;
a fixation mechanism, which engages with the static bracket and the hoist subframe to fixedly connect the static bracket to the hoist subframe; and
wherein the static bracket is configured to be non-dynamically set at an angular position, relative to the hoist subframe.

16. The adjustable mounting point of claim 15, wherein the attachment assembly comprises:
at least one connector;
at least one accessory; and
wherein the at least one connector is configured to be selectively engageable with the pivot bracket on a first end of the at least one connector, and configured to be selectively engageable with an accessory on a second end of the at least one connector.

17. The adjustable mounting point of claim 16, wherein the attachment assembly further comprises at least one support structure, connected to a vehicle body and configured to support the at least one connector.

18. The adjustable mounting point of claim 16, wherein:
the at least one connector is an “L-shaped” bracket; and
the first end of the at least one connector is selectively engageable with the at least one mounting hole.

19. An adjustable mounting point for use with a hoist system, comprising:
a fixed bracket, disposed along the length of a hoist system subframe, having an inside surface, and fixedly connected to either of a first parallel subframe member or a second parallel subframe member;
a pivot bracket, disposed adjacent to the fixed bracket, having an outside surface, and pivotally connected to the fixed bracket;
at least one mounting hole disposed on the pivot bracket outside surface, which at least one mounting hole facilitates connection of an attachment assembly to the pivot bracket;
at least one fixation hole, disposed on the fixed bracket inside surface;
a fixation mechanism, which engages with the at least one fixation hole and the hoist subframe to fixedly connect the fixed bracket to the hoist subframe;
wherein the fixation mechanism is at least one bolt;
at least one pivot hole, disposed on the fixed bracket, corresponding to and concentric with at least one pivot hole disposed on the pivot bracket;
a pivot mechanism, which engages with the fixed bracket and the pivot bracket to pivotally connect the pivot bracket to the fixed bracket;
wherein the pivot mechanism is a bolt, which extends across the length of the adjustable mounting point;
at least one adjustment hole, disposed on the fixed bracket, corresponding to and concentric with at least one adjustment hole disposed on the pivot bracket;
an adjustment mechanism, which facilitates angular adjustment of the pivot bracket, relative to the fixed bracket, between a first angle of 90 degrees, a second angle of 93 degrees, and a third angle of 87 degrees;
wherein the adjustment mechanism is a plurality of bolts, and a correspondingly equal number of bolts is disposed on each of the adjustable mounting point first side and the adjustable mounting point second side;
wherein the attachment assembly includes:
at least one connector;
at least one accessory;
wherein the at least one connector is configured to be selectively engageable with the pivot bracket on a first end of the at least one connector, and configured to be selectively engageable with an accessory on a second end of the at least one connector;
at least one support structure, connected to a vehicle body and configured to support the at least one connector;
wherein the at least one connector is an “L-shaped” bracket; and
wherein the first end of the at least one connector is selectively engageable with the at least one mounting hole.

20. The adjustable mounting point of claim 18, wherein the adjustment mechanism is selectively positionable between any of the at least one adjustment holes to adjust the angular position of the pivot bracket, relative to the fixed bracket, between the first angle, the second angle, and the third angle.
